(19) United States
(12) Patent Application Publication
(10) Pub. No.: US 2016/0032173 A1
(43) Pub. Date: Feb. 4, 2016

(54) Method for the time delayed reduction in viscosity of hydraulic fracturing fluid

(71) Applicant: Roy W. Martin, Downers Grove, IL (US)

(72) Inventor: Roy W. Martin, Downers Grove, IL (US)

(73) Assignee: Truox, Inc., McClellan, CA (US)

(21) Appl. No.: 14/545,894

(22) Filed: Jul. 2, 2015

Related U.S. Application Data
(60) Provisional application No. 61/998,638, filed on Jul. 3, 2014.

(51) Int. Cl. C09K 8/68; E21B 43/26; E21B 43/267; C09K 8/80

(52) U.S. Cl. CPC C09K 8/685; C09K 8/80; E21B 43/26; E21B 43/267

(57) ABSTRACT

The present invention relates to fracturing fluids of the type used in well bore operations and particularly to a method for producing a gradual reduction in the viscosity of a fracturing fluid through the use of slightly water soluble, organic peroxides incorporated in the viscous fluid. The breaker is effective at controlling the rate of viscosity reduction at low temperature and alkaline pH where other chelated metal catalyst fail.

### BACKGROUND OF THE INVENTION

1. Field of the Invention

The present invention relates to fracturing fluids of the type used in well bore operations and particularly to a method for producing a time delayed reduction in the viscosity of a fracturing fluid through the use of slightly water soluble, organic peroxides incorporated in the viscous fluid.

2. Description of the Prior Art

During hydraulic fracturing, a sand laden fluid is injected into a well bore under high pressure. Once the natural reservoir pressures are exceeded, the fracturing fluid initiates a fracture in the formation which generally continues to grow during pumping. The treatment design generally requires the fluid to reach maximum viscosity as it enters the fracture which affects the fracture length and width. The fracturing fluid can be accompanied by a propping agent which results in placement of the propping agent within the fracture thus produced. The proppant remains in the produced fracture to prevent the complete closure of the fracture and to form a conductive channel extending from the well bore into the formation being treated once the fracturing fluid is recovered.

Fluid viscosity relates to the gel's ability to place proppant, influence fracture geometry and enhance fluid loss characteristics. The fracturing fluid's viscosity is normally obtained by using suitable polymers, such as polysaccharides. To further enhance the viscosity, a crosslinking agent is frequently added to the fracturing fluid to gel the polysaccharide.

The recovery of the fracturing fluid is accomplished by reducing the viscosity of the fluid to a low value such that it flows from the formation under the influence of formation fluids and pressure while retaining the proppant within the fracture. This viscosity reduction or conversion is referred to as “breaking” and can be accomplished by incorporating chemical agents, referred to as breakers, into the initial gel.

In addition to the importance of providing a breaking mechanism for the gelled fluid to facilitate recovery of the fluid, the timing of the break is also of great importance. Gels that break prematurely can cause suspended proppant material to settle out of the gel before being introduced a sufficient distance into the produced fracture. Premature breaking can also result in a premature reduction in the fluid viscosity resulting in a less than desirable fracture length in the fracture being created.

On the other hand, gelled fluids that break too slowly can cause slow recovery of the fracturing fluid from the produced fracture with attendant delay in resuming the production of formation fluids. Additional problems can result, such as the tendency of proppant to become dislodged from the fracture, resulting in at least partial closing and decreased efficiency of the fracturing operation.

For purposes of the present application, premature breaking will be understood to mean that the gel viscosity becomes diminished to an undesirable extent before all of the fluid is introduced into the formation to be fractured.

During horizontal fracturing, the fracturing process occurs in a series of stages. Typically it is desirable to have the fracturing gel begin to break when the pumping operations for each stage is concluded. For practical purposes, the gel should be completely broken within a specific period of time after completion of the fracturing period. For example, about 0.5 to 2 hours is a desirable range for the gel to break. A completely broken gel naturally flushes from the formation by the flowing formation fluids or can be recovered by a swabbing operation. In the laboratory setting, a completely broken, non-crosslinked gel is one whose viscosity is less than 400 centipoises, more preferably less than 100 centipoises, and most preferred less than 50 centipoises.

By way of comparison, certain gels, such as those based upon guar polymers, undergo a natural break without the intervention of chemical additives. The break time can be excessively long, however. Accordingly, to decrease the break time of gels used in fracturing, chemical agents are incorporated into the gel and become a part of the gel itself. These chemical agents include, for example, oxidants such as persulfate salts.

However, obtaining delayed breaks using oxidants, such as persulfate salts, to degrade polysaccharide viscosifiers has proved difficult. The rate of degradation usually depends on the temperature and the persulfate concentration. At temperatures above about 140° F., the rate of degradation is difficult to control, often causing a significant loss of viscosity before completing proppant placement. The fracturing fluid loses a sizable fraction of the persulfate when water from the fluid permeates away from the fracture through the porous rock of the formation matrix. The larger polysaccharide simultaneously filters out and adsorbs onto the fracture face, forming a tough, leathery filter cake. Consequently, the relative concentration of polysaccharide steadily increases in the fracture during injection. This filtration effect leaves inadequate amounts of persulfate to degrade both the gel and filter cake. To combat the loss of persulfate to the formation, large amounts of persulfate are used. Large amounts of persulfates, however, can prematurely reduce the fluid viscosity during injection to cause a premature breaking of the gel.

In response to the problems with using oxidants, an encapsulated persulfate segregate it from the fracturing fluid. The persulfate either permeates through the capsule wall or is released by crushing from the proppant during fracture closure, thus delaying gel breaking. Both releases ensure that adequate persulfate is available for complete polysaccharide degradation.

The encapsulated persulfate has some disadvantages. The effectiveness diminishes with increasing temperature. At temperatures exceeding 200° F., most of the persulfate is consumed within the capsule before being released. A pressure differential may form across the coating and force water into the capsule. At high temperature, water reacts with the persulfate within the capsule, thus decreasing the amount of persulfate available. Also, persulfate particles are angular and the capsule thickness can vary across the surface of the particle. This non-uniform thickness causes some thin skinned particles to release too early, causing premature viscosity loss.

Furthermore, coated ammonium persulfate being temperature activated has no means of optimizing the time-increment for delay and gel break other than increasing or decreasing the concentration of coated ammonium persulfate. While 1 lb of coated ammonium persulfate per 1000 gallons of frac water may be sufficient to break the gel, 2-3 lbs may be required to achieve a gel break break within the desired time period under higher temperature conditions. And this method is extremely limited in the ability to optimize the time delay and time of break. The “time-incremented” gel breaker disclosed is superior in the ability to precisely target a time delay and time of break as well as economics of use.

Organic peroxides have been used as gel breakers. However, various organic peroxides are required based on the temperature, and most are hazardous to handle unless temperature controls are provided. The potential for thermal decomposition resulting from storage in field conditions is a real danger. Furthermore, low pH gels stabilize the organic peroxide resulting in extended break times that mirror using no organic breaker at all.

Transition metals have been used as an activator to the organic peroxide. U.S. Pat. No. 4,368,136 describes the use of cupric ions to initiate hydroperoxide. However, cupric ions initiate free radical as the gel is forming, thereby prematurely breaking the gel before it has time to position the proppant within the formation.

EDTA-Cu complexes can be used effectively in alkaline pH (e.g. pH 10.5) gel at high temperatures (e.g. ≧200° F.). However, at lower temperatures (e.g. <180° F.) the ability to perform a gel break in less than or equal to 2 hours, more preferably less than or equal to 1.5 hours, and most preferred less than or equal to 1 hour is not achievable even at higher and costly concentrations of organic peroxide and EDTA-Cu complexes (FIG. 1).

At lower temperatures, the activation energy required to initiate radical formation from organic peroxides (e.g. tert butyl hydroperoxide) is difficult to achieve. Desirable activators lower the activation energy needed to initiate radical formation. Chelated transition metal ions (e.g. cupric ions) such as Cu-EDTA are over stabilized and substantially delay or all together prevent the initiation of free radical formation under conditions that stabilize the organic peroxide (FIG. 1). While Cu-EDTA may work well at high temperature and alkaline pH conditions, they do not lower the activation energy of the organic peroxide under conditions of low to moderate temperature where the organic peroxide is stabilized and the activation energy is not achieved or is delayed for an unacceptable period.

The difficulty in developing an activator comprising a metal catalyst and chelant(s) used to stabilize the catalyst is further increased when zirconium or titanium crosslinked gels are used. For example, zirconium (IV) has a strong affinity to many chelants exemplified by HEDTA and EDTA. If the stability constant between the chelant and catalyst is significantly lower than the stability constant between the chelant and crosslinker (e.g. zirconium), the catalyst is released by the chelant in favor of complexing with the zirconium. In this example, the gel viscosity does not increase to the desired centipoises, and the released catalyst is rapidly oxidized and depleted before the remaining gel is broken. Manganese-HEDTA has demonstrated this type of behavior due to the relatively low stability constant of the Mn-HEDTA complex (approximate pKs=11) versus the stability constant between Zr-HEDTA (approximate pKs=28).

While prior art generally references using iron-chelant activators, at alkaline pH the competing reaction between hydroxide anions and chelant induce precipitation of the iron even when chelated with HEDTA, thereby negating any benefit as an activator of organic peroxide under alkaline pH (e.g. ≧9.0) conditions.

It has been found that activators comprising cobalt-ligand complex having a positive coordinate to primary ligand balance of from +1 to +4, more preferably +1 to +3 provides the desirable delay for initiating free radical formation at lower to moderate temperatures and under alkaline pH conditions where other metal-chelant complexes fail to perform due to sufficient lowering the activation energy of the organic peroxide or loosing catalytic activity due to precipitation.

A time delayed manner allows the gel to achieve its desired viscosity within the formation before initiating the breaking of the gel. The activators of the invention comprising a cobalt-ligand complex having a positive coordinate to primary ligand balance of from +1 to +4 effectively initiate free radical generation even under low temperature (≧140° F.) and alkaline pH conditions while providing desirable delay and stability thereby preventing precipitation.

The activators of the invention provide desirable delay before initiating free radical formation under low temperatures (≧140° F). and alkaline pH (pH≧9.0). Once free radical formation is initiated, the catalytic effect of the cobalt ion accelerates free radical formation and subsequent drop in viscosity. The activators of the invention have particular utility where zirconium and/or titanium crosslinkers are employed due to the low stability constant between the specified chelants and said crosslinkers.

The present invention has as its object to provide a break mechanism for a gelled fracturing fluid which yields high initial viscosity with little change during pumping but which produces a rapid break in the gel after pumping is completed to allow immediate recovery of the fluid from the formation.

Another object of the invention is to provide a gel system for a well fracturing operation which can break the gel polymers at a controlled rate and at low to moderate temperatures (from about 140° F. to 180° F.) without interfering with the crosslinking chemistry and causing premature breaking.

Another objective of the invention is to provide a gel system for a well fracturing operation which can break the gel polymers at low to moderate temperature (from about 140° F. to 180° F.) and high (alkaline) pH at a controlled rate, thereby tailoring the gel breaker to the time constraints of the fracturing operation.

### SUMMARY OF THE INVENTION

### BRIEF DESCRIPTION OF FIGURES

FIG. 1—A HTHP 5550 Viscometer available through Chandler Engineering was used to conduct gel breaker testing. The graph compares the zirconium crosslinked gel breaking performance of TBHP activated by Cu-EDTA versus several examples of Co-EDG activator using 5 wt % TBHP at either comparable or lower concentrations than that used with the Cu-EDTA. The results clearly illustrate that copper based activators do not effectively reduce the activation energy at low temperature while the cobalt based activators effectively break the gel even at lower concentration of TBHP.

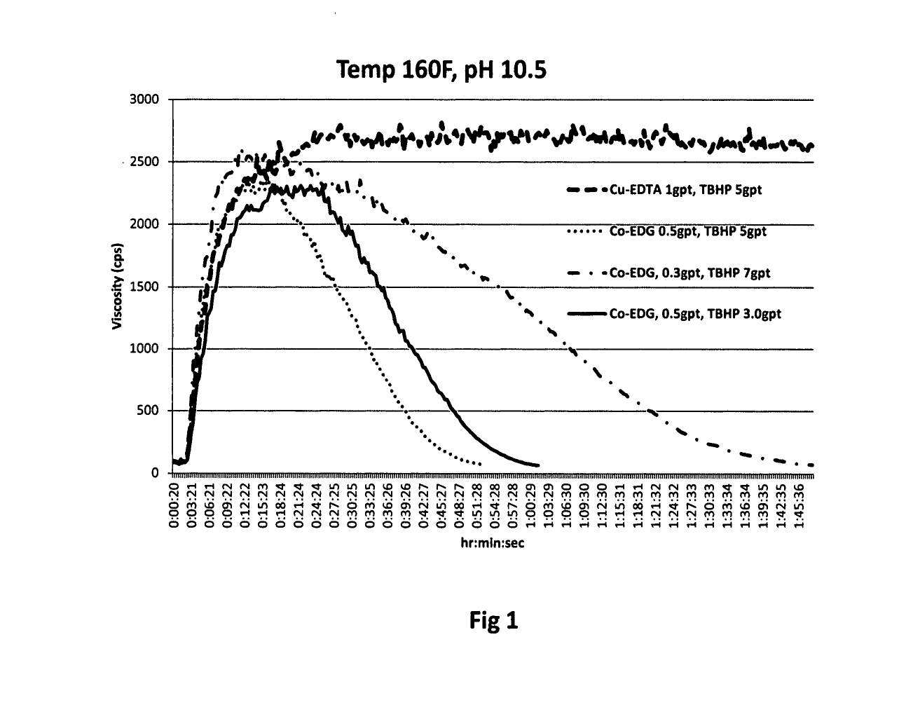

FIG. 2—compares various concentrations of Co-EDG using varying concentrations of 5% TBHP to cobalt-EDTA at 160° F. and pH 10.5. The data clearly shows the increased rate of viscosity reduction even using lower concentrations of TBHP compared to the highly stabilized Co-EDTA.

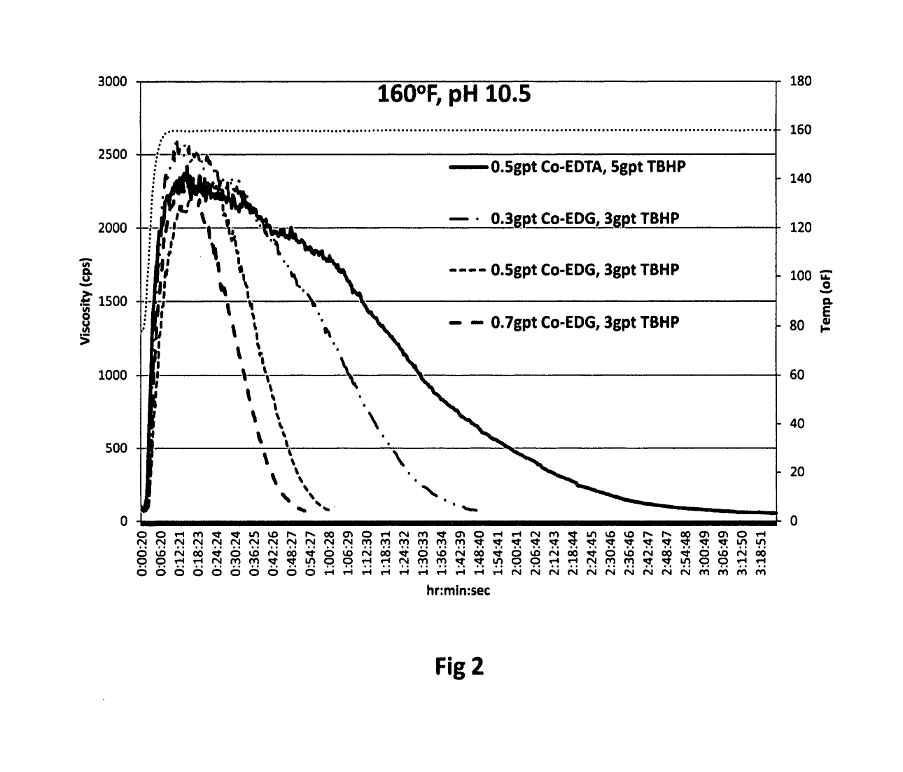

FIG. 3 illustrates the inability of ferric-HEDTA to function as an activator under the conditions described.

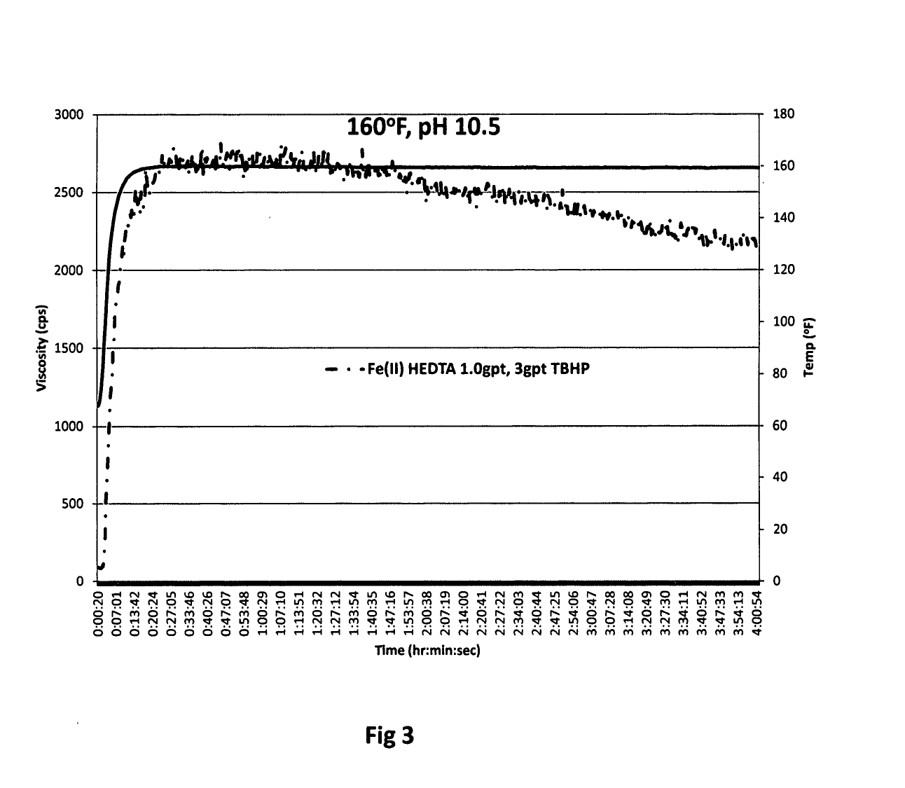

In the method of the invention, a gellable fracturing fluid is formulated by blending together an aqueous fluid, a hydratable polymer, which is capable of forming a polymer gel, a crosslinking agent for crosslinking the hydratable polymer, proppant and gel breaker comprising aqueous organic peroxide solution and an activator comprising cobalt-ligand complex. The gel breaker is effective to degrade the polymer gel at temperatures greater than about 140° F. and at a pH range of about 9 to about 12.

Preferably, the gellable fracturing fluid is formulated by blending together an aqueous fluid, a hydratable polymer, a crosslinking agent for crosslinking the hydratable polymer, proppant and gel breaker comprising aqueous organic peroxide solution and activator comprising cobalt-ligand complex. The fluid is then pumped to a desired location within the well bore under sufficient pressure to fracture the surrounding subterranean formation. Thereafter, the breaker degrades the polymer, whereby the fluid can be pumped from the subterranean formation to the well surface.

Additional objects, features and advantages will be apparent in the written description that follows.

### DETAILED DESCRIPTION OF THE INVENTION

As used herein, “activator” is an aqueous solution comprising a coordinate bonded complex between a peroxide activating transition metal ion comprising cobalt ion and at least a primary ligand donor. An activator comprising a cobalt ion and primary ligand donor results in a positive coordinate to ligand balance ranging from +1 to +4, more preferably +1 to +3 that are desirable for lower temperatures (e.g. 140° F. to about 200° F.) and alkaline pH (greater than 9.0). An activator comprising a cobalt ion and primary ligand donor may have at least one auxiliary ligand donor to achieve the level of stability and activation profile for a particular application.

As used herein, “peroxide activating transition metal ion” comprise cobalt ions that are effective at inducing the formation of at least hydroxyl free radicals (OH.) when reacted with organic peroxide having the general formula:

R₁—O—O—R₂

Wherein R₁ comprises a carbon based structure, and R₂ comprises hydrogen or a carbon based structure. The carbon based structure may be alkyl, cyclic, aryl, branched, substituted or un-substituted.

As used herein, “gel breaker” comprises an organic peroxide and/or hydroperoxide and an activator comprising a peroxide activating transition metal ion coordinate bonded to a primary ligand donor, and wherein the coordinate to ligand balance ranges from +1 to +4, more preferably +1 to +3.

As used herein, “coordinate to primary ligand balance” describes the balance between the positive charged transition metal coordinate sites and the negative charged ligands resulting from the bond between the transition metal ion and the ligand donor(s). A coordinate to primary ligand balance that is positive (+) means there are open or free coordinate sites. A coordinate to primary ligand balance that is zero (0) indicates that all of the coordinate sites are filled by a ligand. A coordinate to primary ligand balance that is negative (−) indicates that all of the coordinate sites are filled and there is an excess of ligand available.

As used herein, “time-incremented” also “time-increment” describes the ability of the gel breaker system to incrementally increase or decrease the delay period and time of gel break by time increments of less than or equal to 20 minutes, more preferred 15 minutes, and most preferred 10 minutes. The changes in time increments can be achieved by increasing or decreasing the concentration of activator and/or hydroperoxide under the temperature and pH conditions disclosed, while achieving a time of gel break from 30 minutes to about 120 minutes. Preferably the time of break is achieved by optimizing the amount of activator thereby achieving gel break without significantly increasing the amount of oxidizer (e.g. hydroperoxide). The time-incremented gel break can be increased or decreased by less than or equal to 20 minutes, more preferably 15 minutes, and most preferred 10 minutes by increasing or decreasing the concentration of cobalt-ligand complex by less than or equal to 1.5 ppm measured as cobalt (Co).

As used herein, “coordination sites” are the locations of the transition metal where ligands complex with the transition metal ion. Cobalt ions in aqueous solution are known to possess six coordination sites that can be complexed with ligands.

As used herein, “primary ligand donor” is the ligand donor that forms a coordinate bond with the peroxide activating transition metal ion (e.g. cobalt ion) and results in a coordinate to primary ligand balance in the range of +1 to +4, more preferably +1 to +3. The primary ligand donor possesses a higher stability constant with cobalt than does an auxiliary ligand donor. The primary ligand donor is combined with the peroxide activating transition metal ion (cobalt) at sufficient stoichiometry as to achieve the desired coordinate to primary ligand donor balance in the range of +1 to +4, more preferably +1 to +3. The range may vary depending on the number of ligands on the ligand donor and the stoichiometric ratio between the cobalt ion and ligand donor. Some compounds in the matrix of the cobalt primary ligand complex may have more coordination sites complexed while other compounds have fewer coordination sites complexed with the primary ligand donor. The preferred primary ligand donors are selected from the amino acid glycinic acid and glutamic acid and/or derivatives of said amino acids. Preferred non-limiting derivatives include ethanol diglycinic acid (EDG) and glutamic acid, N,N-diacetic acid (GLDA).

As used herein, “auxiliary ligand donor” comprises one or more ligand donors that are used in conjunction with the primary ligand donor to provide temporary filling of the coordination sites remaining on the activator, or may be used to provide for an activator having a variable activation profile. For illustration purposes, in one non-limiting example cobalt may be complexed with a stoichiometric concentration of EDG, resulting in coordinate to ligand balance of from +2 to +3 depending on the pH and the degree of activation of the hydroxyl group on the EDG. In this example, acetic acid, formic acid or similar organic acids as well as an amino acid glycinic acid may be used to complex with some or all of the remaining coordination sites to provide at least temporary filling, improved solubility and/or stability.

Non-limiting examples of auxiliary ligand donors include: amino acids comprising glycine, arginine, histidine, lysine, aspartic acid, glutamic acid, serine, threonine, asparagines, glutamine, proline, alanine, valine, isoleucine, phenylalanine, tyrosine; alpha and beta hydroxy carboxylic acid comprising glycolic acid, lactic acid, citric acid, mandelic acid, tartaric acid, salicyclic acid; organic acids exemplified by formic acid, acetic acid, propionic acid and the like.

Non-limiting examples for sources of cobalt ions include: cobalt chloride, cobalt sulfate, cobalt nitrate, cobalt acetate, cobalt carbonate, cobalt hydroxide, cobalt glycinate and the like.

Discussion:

The activator composition and selection is crucial to optimize gel breaker efficiency as well as control the rate of viscosity drop. Proper selection of activator can reduce the concentration of organic peroxide required while achieving comparable rates of reduction in viscosity.

Furthermore, proper activator composition and selection provides the ability to control the rate of gel break under various pH and moderate to low temperatures that otherwise would result in less than satisfactory reduction rates in gel viscosity.

Without being bound to a specific theory, it is believed the activator comprising cobalt-ligand complex results in a complex that provides sufficient steric hindrance to prevent premature gel break. However, once coordination sites interact with the organic peroxide, free radicals are produced which then accelerate the release of more coordination sites. The cobalt provides far greater activity compared to metal ions exemplified by cupric ions. The cobalt performs superior to cupric ions under low to moderate temperature that stabilize the organic peroxide (e.g. tert butyl hydroperoxide). The cobalt is superior to cupric ions at lowering the activation energy of TBHP and other organic peroxides. Once interactions between the coordination sites and organic peroxide take place, hydroxyl radicals begin the process of reducing the gel viscosity as well as exposing more coordination sites. At low to moderate temperatures, the activation energy or the organic peroxide must be sufficiently reduced to initiate radical formation in a timely fashion. Structuring the activator to provide available coordination sites accelerates the initiation of radical formation thereby allowing gel breaking in a preferred and controlled time period. The activator comprising cobalt-primary ligand complexes is not limited exclusively to an activator having a coordinate to primary ligand balance in the range of +1 to +4. For example, a portion of the cobalt used for activating the organic peroxide may be combined with EDTA to form a more stable and less active activator. The remaining portion is then complexed with a primary ligand donor that results in a coordinate to ligand balance in the range of +1 to +3 (e.g. EDG). This results in an activator profile that allows some of the coordinate sites comprising the Co-EDG complex to remain open to initiate free radical formation at increased rate, while the Co-EDTA is delayed for an extended period before opening of the coordinate sites thereby allowing for delayed activation but eventual release of a high number of catalytically available cobalt coordination sites.

In order to practice the method of the invention, an aqueous fracturing fluid is first prepared by blending a hydratable polymer into an aqueous fluid. The aqueous fluid could be, for example, water, brine, aqueous based foams or water-alcohol mixtures. Any suitable mixing apparatus may be used for this procedure. In the case of batch mixing, the hydratable polymer and the aqueous fluid are blended for a period of time which is sufficient to form a hydrated solution. The hydratable polymer useful in the present invention can be any of the hydratable polysaccharides that are familiar to those in the well service industry. These polysaccharides are capable of gelling in the presence of a crosslinking agent to form a gelled based fluid. For instance, suitable hydratable polysaccharides are the galactomannan gums, guars, derivatized guars, cellulose and cellulose derivatives. Specific examples are guar gum, guar gum derivative, locust bean gum, caraya gum, xanthan gum, cellulose, and cellulose derivatives. The preferred gelling agents are guar gum, hydroxypropyl guar, carboxymethyl hydroxypropyl guar, cellulose, carboxymethyl cellulose, carboxymethyl hydroxyethyl cellulose and hydroxyethyl cellulose. The most preferred gelling agents are guar gum, hydroxypropyl guar, carboxymethyl hydroxypropyl guar, hydroxyethyl cellulose and carboxymethyl hydroxyethyl cellulose.

The method of the invention reduces the viscosity of other polysaccharides used in the oil industry as well. These polysaccharides are not crosslinked. Polysaccharides, such as starch, thicken fluids or control fluid loss. Starch or derivatized starch, whether water soluble or insoluble, can be used. Xanthan gums are often used as sand control agents. Therefore, whenever the terms “breaker” and “breaking” are used generically in this disclosure and claims, the terms also encompass the method of reducing the viscosity of fluids with viscous, noncrosslinked polysaccharides such as starches, xanthans, and the like.

Propping agents (also referred to as “proppant”) are typically added to the base fluid prior to the addition of the crosslinking agent. Propping agents include, for instance, quartz sand grains, glass and ceramic beads, walnut shell fragments, aluminum pellets, nylon pellets, and the like. The propping agents are normally used in concentrations between about 1 to 18 pounds per gallon of fracturing fluid composition, but higher or lower concentrations can be used as required. The base fluid can also contain other conventional additives common to the well service industry such as surfactants, and the like.

In the invention, the breaker is an aqueous organic peroxide solution and activator comprising cobalt-ligand complex. In this disclosure, the term “organic peroxide” refers to organic peroxides and organic hydroperoxides in an aqueous solution. The active portion of the organic peroxide may range from 1 to 85 wt % with the remaining typically being predominately water (aqueous solution).

The organic peroxides of the invention should also have large activation energies for peroxy radical formation and relatively high storage temperatures that usually exceed 80° F. High activation energies and storage temperatures of the organic peroxides of the invention lend stability which provides a practical shelf life. Preferred organic peroxides are tert butyl hydroperoxide and t-amyl hydroperoxide and mixtures thereof. The organic peroxide solution to be applied to the fracturing fluid may comprise from 1 wt % to 85 wt % of active organic peroxide. However, it is desirable to use diluted solutions that are safer for handling, storage and transport. Tert butyl hydroperoxide (TBHP) and t-amyl hydroperoxide can be safely stored and shipped at active concentrations ranging between 1 to 10 wt % in an aqueous solution.

The preferred organic peroxide of the invention comprises tert butyl hydroperoxide (TBHP) having between 1 to 10 wt %, more preferably between 2 to 8 wt %, most preferred between 4 to 6 wt % based on the active proportion of TBHP and water. As used herein “water” is used generically to describe an aqueous solution comprising predominantly water having the general formula H₂O. Other ingredients exemplified by pH buffers, chelant, methanol etc. may be added to or included in the aqueous solution. It is preferred the water used to dilute concentrated (70 to 85 wt %) TBHP comprise demineralized, distilled water, or softened water.

The following model is intended to aid in understanding the method without limiting the invention's scope. After adding the organic peroxide and activator, and pumping, the fracturing fluid heats to temperatures near the reservoir temperature. Once the fracturing fluid has reached a temperature of greater than 140° F., the activator comprising cobalt-primary ligand complex lowers the activation energy of the organic peroxide inducing cleavage of the peroxide bond to form free radicals. These free radicals collide with the polymer initiating and propagating the decomposition of the polymer.

The rate of the organic peroxide degradation depends on temperature, the pH, the organic peroxide concentration, coordinate site opening on the cobalt-primary ligand complex, and the activator concentration. The amount of organic peroxide and activator used is an amount sufficient to decrease viscosity or break a gel without a premature reduction of viscosity. Preferably, the amount of organic peroxide based on active ingredient ranges from about 25 to about 250 ppm based on the fracturing fluid. In this non-limiting example, an aqueous solution of tert butyl hydroperoxide comprising 5 wt % active TBHP would typically be dosed at 0.5 gpt to 5 gpt (gallons per thousand) per 1000 gallons of fracturing fluid. However, the concentration depends on both polysaccharide content, typically about 0.24% to about 0.72% (weight/volume) the temperature and pH. The applicable temperature is greater than or equal to 140° F. The applicable pH ranges from about 9 to about 12.

The concentration of aqueous organic peroxide solution provides from 25 to 250 ppm of active organic peroxide based on the amount of fracturing fluid.

A controlled break can be achieved by the selection of the cobalt-ligand complex and/or varying the concentration of organic peroxide and/or activator.

The concentration of active cobalt-ligand complex based on active cobalt reported as Co in the fracturing fluid can range from 3 to 40 ppm.

The fracturing fluids of the invention often include a crosslinking agent. The crosslinking agent can be any of the conventionally used crosslinking agents which are known to those skilled in the art. For instance, in recent years, gellation of the hydratable polymer has been achieved by crosslinking these polymers with metal ions including aluminum, antimony, zirconium, for example, zirconium chelates such as zirconium acetate, zirconium lactate, zirconium lactate triethanolamine and titanium containing compounds including the so-called organotitinates, for example, the titanium chelates such as triethanolamine titanates, titanium acetylacetonate and titanium lactate. See, for instance, U.S. Pat. No. 4,514,309.

In the case of borate crosslinkers, the crosslinking agent is any material which supplies borate ions in solution. Thus the crosslinking agent can be any convenient source of borate ions, for instance the alkali metal and the alkaline earth metal borates and boric acid. One such crosslinking additive is sodium borate decahydrate, the crosslinking agent described in Dawson's U.S. Pat. No. 5,160,643. In a guar gel, this crosslinking additive is preferably present in the range from about 0.024% to in excess of 0.18% by weight of the aqueous fluid. Preferably, the concentration of crosslinking agent is in the range from about 0.024% to about 0.09% by weight of the aqueous fluid.

The crosslinking additive may also effect the required organic peroxide concentration. Some components in the crosslinking additives, for example glyoxal, are easily oxidizable. Other components, for instance triethanolamine, are initiation catalysts, although low temperature activation catalysts have less of an effect on the organic peroxides of the invention. Therefore, the concentration of the organic peroxide should be adjusted for these effects.

In a typical fracturing operation, the fracturing fluid of the invention is pumped at a rate sufficient to initiate and propagate a fracture in the formation and to place propping agents into the fracture. A typical fracturing treatment would be conducted by hydrating a 0.24% to 0.72% (weight/volume [w/v]) polysaccharide based polymer, such as guar, in a 2% (w/v) KCl solution. During the actual pumping, as described, the pH is adjusted by the addition of a buffer, followed by the addition of the breaker, crosslinking agent, proppant and other additives if required.

Although several methods of the invention are described above, no best mode of the invention currently exists. The following examples illustrate that the breaker is effective and remains effective using different crosslinkers and different breakers.

What is claimed is:

1. A method of fracturing a subterranean formation which surrounds a well bore comprising the steps of:
formulating a gellable fracturing fluid by blending together an aqueous fluid, a hydratable polymer, proppant, a suitable crosslinking agent for crosslinking the hydratable polymer to form a polymer gel, and a breaker comprising aqueous organic peroxide solution and cobalt-primary ligand complexes having a coordinate to primary ligand balance in the range of +1 to +4;
pumping the gellable fracturing fluid to a desired location within the well bore under sufficient pressure to fracture the surrounding subterranean formation;
allowing the fracturing fluid to achieve a temperature of greater than or equal to 140° F.;
allowing the breaker to degrade the polymer gel and produce a pumpable fluid, and
wherein the pH of the fracturing fluid is between 9 and 12.

2. The method of claim 1, wherein the aqueous organic peroxide solution is selected from at least one of tert butyl hydroperoxide, t-amyl hydroperoxide and mixtures thereof.

3. The method of claim 1, wherein the aqueous organic peroxide solution comprises tert butyl hydroperoxide.

4. The method of claim 3, wherein the aqueous organic peroxide solution comprises from 1 to 10 wt % tert butyl hydroperoxide.

5. The method of claim 4, wherein the aqueous organic peroxide solution comprises from 4 to 6 wt % tert butyl hydroperoxide.

6. The method of claim 1, wherein the concentration of aqueous organic peroxide solution provides from 25 to 250 ppm of active organic peroxide based on the amount of fracturing fluid.

7. The method of claim 1, wherein the cobalt-primary ligand complex comprises Co-EDG.

8. The method of claim 1, wherein the cobalt-primary ligand complex comprises Co-Glycine.

9. The method of claim 1, wherein the cobalt-primary ligand complex comprises Co-GLDA.

10. The method of claim 1, wherein the concentration of cobalt-primary ligand balance is from 3 ppm to 40 ppm based on active cobalt reported as Co.

11. The method of claim 1, wherein the breaker degrades the polymer gel and produces a pumpable fluid in less than 2 hours.

12. The method of claim 11, wherein the breaker degrades the polymer gel and produces a pumpable fluid in less than 1.5 hours.

13. The method of claim 12, wherein the breaker degrades the polymer gel and produces a pumpable fluid in less than 1 hour.

14. The method of claim 1, wherein the crosslinker is selected from at least one of zirconium and titanium.

15. The method of claim 14, wherein the crosslinker comprises zirconium.

16. The method of claim 14, wherein the crosslinker comprises titanium.

17. The method of claim 1, wherein the hydratable polymer is selected from the group consisting of:
galactomannan gums, guars, derivatized guars, cellulose and derivatized celluloses.

18. The method of claim 1, wherein the hydratable polymer is selected from the group consisting of:
guar gum, hydroxypropyl guar, carboxymethyl hydroxypropyl guar, cellulose, carboxymethyl cellulose, carboxymethyl hydroxyethyl cellulose and hydroxyethyl cellulose.

19. The method of claim 1, wherein the amount of cobalt-primary ligand complex is sufficient to provide from 3 to 40 ppm of cobalt reported as Co.

20. The method of claim 1, wherein the cobalt-primary ligand complexes have a coordinate to primary ligand balance in the range of +1 to +3.
